(19) United States
(12) Patent Application Publication
(10) Pub. No.: US 2010/0191496 A1
(43) Pub. Date: Jul. 29, 2010

(54) METHOD FOR COMPENSATING FOR TEMPERATURE MEASUREMENT ERROR IN A SOND

(75) Inventors: Hans-Karl Von Bagh, Porvoo (FI); Jyrki Stor-Pellinen, Vantaa (FI)

Correspondence Address: BIRCH STEWART KOLASCH & BIRCH, PO BOX 747, FALLS CHURCH, VA, 22040-0747, US

(73) Assignee: VAISALA OYJ, Vantaa (FI)

(21) Appl. No.: 12/664,544

(22) PCT Filed: Jun. 6, 2008
(86) PCT No.: PCT/FI2008/050334

§ 371 Date: Dec. 14, 2009

(30) Foreign Application Priority Data
Jun. 20, 2007 (FI) 20075470

(51) Int. Cl. G01W 1/08; G01K 1/20

(52) U.S. Cl. 702/99

(57) ABSTRACT

The invention relates to a method for correcting a radiation error in atmospheric temperature measurement, particularly when using a radiosonde (1), a rocket, or a dropsonde, in which method at least one temperature measurement sensor is used in each measuring device. According to the invention, the state of motion of the sonde (1) relative to the ambient air is measured essentially simultaneously with the temperature measurement, and the result of the measurement result is used to correct the error of the temperature measurement.

The present invention relates to a method, according to the preamble of claim 1, for compensating for a temperature-measurement error in a sonde.

A sonde is a weather-observation device, which attached to a gas balloon, typically measures atmospheric temperature, pressure, and humidity, as well wind, at various altitudes.

At present, only the rate of ascent is used as a ventilation factor. Horizontal velocity is significant, especially in single-sonde sounding. Traditionally, it has not been understood that the horizontal velocity of a sonde is significant, or that the horizontal velocity relative to the air can be determined.

The most important source of error in atmospheric temperature measurements is the radiation error of the temperature sensor. This error increases particularly as the sonde rises, whereby the density of the air surrounding the sonde decreases. A temperature sensor always measures its own temperature. For a temperature sensor to measure the temperature of the ambient air, heat exchange must take place between the sensor and the ambient air. Convective heat transfer takes the temperature of the sensor towards the temperature of the ambient air. Radiative heat transfer typically deviates the temperature of the sensor from the temperature of the ambient air. As altitude increases, and atmospheric pressure decreases, the convective transfer of heat between the sensor and the ambient air weakens. On the other hand, radiative heat transfer strengthens as the sonde rises. For this reason, the temperature of the sensor is not the same as the temperature of the ambient air, but is either higher or lower, always according to the atmospheric radiation conditions.

The transfer of heat between a temperature sensor and the ambient atmosphere is described by the equation in a state of equilibrium:

−H(Tₛ−T)−σεATₛ⁴+εR+γS=0 (1)

in which Tₛ is the temperature of the sensor (K)
T is the temperature of the air (K)
H is the convective heat-transfer coefficient (W/K)
σ is the Stefan-Boltzmann constant (5.67*10⁻⁸ W/m²K⁴)
ε is the emissivity of the surface of the sensor
A is the surface area of the sensor (m²)
R is the power (W) of the long-wave thermal radiation acting on the sensor
γ is the absorption coefficient of the surface of the sensor for short-wave (solar) radiation
S is the power (W) of the solar radiation acting on the sensor.

In the equation, the first term, −H(Tₛ−T) depicts convective heat transfer. The last three terms depict radiative heat transfer. The term −σεATₛ⁴ depicts the thermal radiation emitted by the sensor, εR absorbed by the sensor (so-called long-wave radiation λ=5 . . . 50 μm) and the term γS represents the absorbable solar radiation (short-wave radiation, λ=0.2 . . . 2.5 μm).

In order to estimate the radiation error, two or more sensors, of identical dimensions, but surfaced in different ways, can be used. Each surfacing has a different emissivity for thermal radiation and a different absorption coefficient for solar radiation. Correspondingly, sensors surfaced in different ways have radiation errors of different magnitudes and display different temperatures, the magnitudes of which depend on the atmospheric radiation conditions. Its own heat-transfer equation (1) can be written for each sensor, whereby an equation group of two or more equations are obtained, as well as a corresponding number of unknowns, if the shapes and dimensions of the sensors are mutually the same and the optical properties of each surfacing are known. The remaining unknowns—among them T, the real temperature of the atmosphere—can then be solved from the equation group. The weakness of this method is that the differences of the sensors, in terms of both measurement inaccuracy and sensor geometry, increase the measurement error. Sondes containing several (at least 2) sensors also increase the costs of the sondes, so that such multi-heat sensor sondes are not used in standard soundings for reasons of cost.

Radiation error can be reduced up to a certain limit by making the dimensions of the sensor small, whereby the convective heat transfer will be boosted relative to the radiative heat transfer. Another way is to surface the sensor with a surfacing with the lowest possible absorption coefficient. Both of these methods are used in known solutions. However, radiation error cannot be entirely eliminated using these methods, because neither the dimensions nor the absorption coefficient can be reduced to be infinitely small. The remaining radiation error is corrected away computationally by exploiting atmospheric radiation conditions and pressure, as well as the rate of ascent of the sonde.

The invention relates to a method for compensating for radiation error in temperature measurement in radiosonde sounding. According to the method, at least one temperature-measuring sensor is used in each sonde. A standard sonde measures besides temperature and humidity, also the speed and direction of the wind. The wind is measured by measuring the location or speed of the sonde at each moment.

Because the sonde and balloon assembly moves horizontally with the air, the velocity of the sonde caused by pendulum motion is the same as the velocity of the sonde relative to the air horizontally. If the square of the rate of ascent of the sonde is added to the horizontal velocity, the total ventilation of the sensor can be calculated.

The invention is based on using the real flight velocity of the sonde relative to the ambient air instead of the rate of ascent of the sonde, when correcting radiation error. The computational correction then becomes considerably more precise.

According to the invention, along with the temperature measurement, the ventilation of the temperature sensor is measured on the basis of the speed of flight of the sonde.

More specifically, the method according to the invention is characterized by what is stated in the characterizing portion of claim 1.

Considerable advantages are gained with the aid of the invention.

A method of this kind has several advantages over the aforementioned traditional radiation-correction method:

1. The correction of radiation error becomes substantially more accurate. The rate of ascent of a sonde typically varies between 5 and 7 m/s and the lateral velocity of the sonde typically varies between 2 and 20 m/s. By taking the real ventilation velocity into account, the radiation-error correction of the temperature measurement becomes correspondingly more accurate when correcting radiation error.

2. Changes in the sounding arrangement in climatological soundings series are taken into account in the case of change in the ventilation of the temperature sensor, by reducing the errors depending on changes in the measurement systems.

3. A single temperature sensor is sufficient.

A standard sonde measures besides temperature and humidity, also the speed and direction of the wind. The wind speed is obtained by measuring the momentary position or speed of the sonde, most generally by using GPS positioning. Radar, radionavigation, or radio directioning are also used to measure the position or speed of the sonde.

The invention will be examined according to an embodiment according to the accompanying FIGURE.

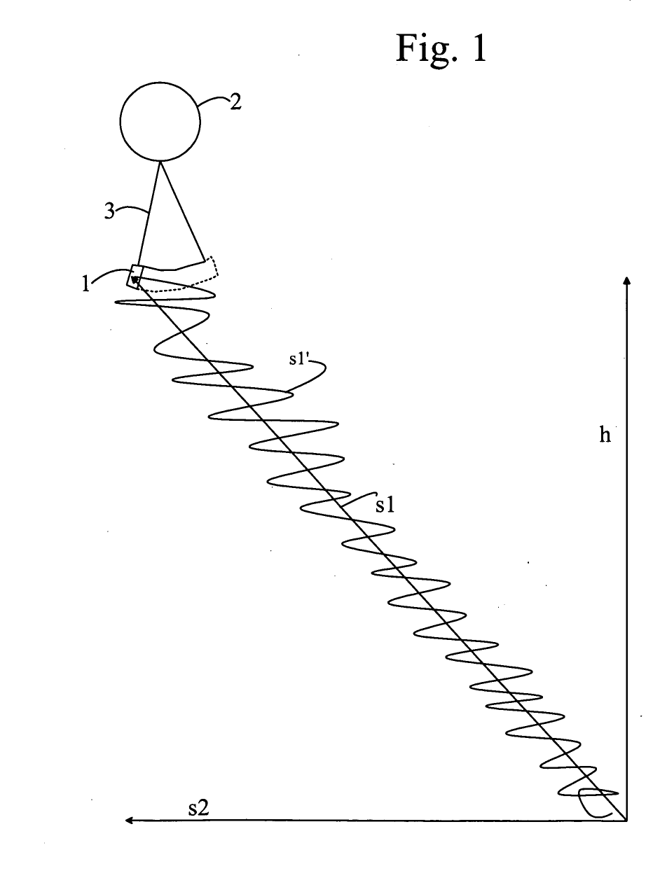

FIG. 1 shows schematically the motion of a sonde-balloon combination.

In FIG. 1, the sonde 1 is attached to the balloon by a cord 3. The motion of the sonde 1 is formed of a vertical motion h and a horizontal motion s2, as well as of a pendulum motion, which causes the sonde 1 to swing at the end of the cord 3. The path of the sonde 1 is depicted without the swinging by the symbol s1 and with the swinging by the symbol s1′.

The ventilation caused by the motion of the sonde 1 will be examined in greater detail hereinafter.

The combination of the balloon and the sonde flies horizontally transported by an air current. Because in the upper atmosphere (the stratosphere) wind eddies (i.e. local changes in the speed or direction of the wind) are small, the balloon 2 and the sonde 1 rapidly accelerate horizontally to the speed of the wind current, whereby the thrust caused by the wind ceases. In an area of steady wind, the balloon 2 and sonde 1 combination follows the movements of the ambient air very precisely in the horizontal plane. I.e., the common centre of gravity of the balloon and sonde moves with the air horizontally in calm air. In the vertical direction, the buoyancy of the balloon produces an upward rate of ascent relative to the air.

The air resistance decreases sharply as the pressure drops. When the very low air resistance in the upper atmosphere prevails, the sonde swings very strongly like a pendulum, suspended from the balloon. This pendulum motion is particularly strong in the case of a single sonde, but is substantially weaker in multi-sonde tests. The pendulum has a pendular period, which pendular period is proportional to the square root of the length of the pendulum. In other words, after one pendular period, the sonde 1 is in its original position relative to the balloon. By averaging the motion data of the sonde 1 in the horizontal plane over one pendular period, the motion of the centre of gravity of the balloon 2 and pendulum for the period of time in question will be known, which is also the movement of the ambient air. The momentary motion of the sonde, reduced by this average, is then the motion of the sonde relative to the ambient air, in the horizontal direction. When the vertical motion of the sonde is added to this, the ventilation of the sonde can then be calculated separately for each moment.

The operation of the invention is in no way dependent on how the path of the sonde has been measured. The most usual ways are GPS positioning, measurement of the frequency shift of a GPS signal, radar, radio-navigation, or radio directioning. The relative state of motion of a sonde can also be measured from the Doppler shift of the carrier-wave frequency transmitted by the sonde, without additional costs attached to the sonde. The relative state of motion of the sonde can, of course, also be measured using sensors intended for this, such as inertia-measurement, acceleration, tilt, or force sensors (measurement of the tension in the cord between the sonde and the balloon).

### Mathematical Description

All positioning method based on position give the co-ordinates of the sonde in either a rectangular co-ordinate system, or in a spherical co-ordinate system. These co-ordinates can be converted to a rectangular co-ordinate system (x,y,z), in which the z-axis can be selected to depict the elevation of the sonde. The position of the sonde can be shown at a moment tᵢ in a rectangular co-ordinate system, by three numbers xᵢ, yᵢ, and zᵢ; in which xᵢ is the distance on the x-axis of the sonde from the origin of the co-ordinate system and yᵢ and zᵢ are correspondingly its distances on the y and z axes.

The momentary velocity of the sonde in the direction of each axis is then:

vₓᵢ=(xᵢ₊₁−xᵢ)/(tᵢ₊₁−tᵢ), momentary velocity in the x-axis direction

v_{yi}=(yᵢ₊₁−yᵢ)/(tᵢ₊₁−tᵢ), momentary velocity in the y-axis direction

v_{zi}=(z_{zi+1}−zᵢ)/(tᵢ₊₁−tᵢ), momentary velocity in the z-axis direction, i.e. rate of ascent

Many positioning methods provide direct momentary velocity values for each co-ordinate state, instead of a momentary position (e.g., methods based on Doppler frequency shift).

The sonde-cord-balloon system forms a pendulum. After an entire pendular period, the pendulum is always in the same original state of motion. This means that the velocity component caused by the pendulum motion is cancelled, if an average is made over one or more complete pendular periods. The sonde-balloon system moves in the x, y plane transported by an air current in calm air. Thus the horizontal velocity of the sonde (in the directions of the x and y-axes) averaged over one or more pendular periods correspond to the horizontal velocity of the air surrounding the sonde, i.e. the wind.

v_{xi,wind}=mean value(v_{xi-n/2} . . . v_{xi+n/2})

v_{yi,wind}=mean value(v_{yi-n/2} . . . v_{yi+n/2})

in which n corresponds to number of samples over one or more complete pendular periods.

The sonde/balloon system moves in the x,y plane transported by the air current. The ventilation acting on the sensors of the sonde arises from the rate of ascent of the sonde and the horizontal air current created by the pendulum motion. The horizontal air current acting on the sonde is obtained by calculating the momentary horizontal velocity of the sonde, reduced by the horizontal velocity of the ambient air of the sonde:

v_{xi,ventilation}=vₓᵢ−v_{xi,wind}

v_{yi,ventilation}=v_{yi}−v_{yi,wind}

The total ventilation acting on the sonde is obtained at each moment by adding the squares of the rate of ascent of the sonde and the components of the horizontal air current acting on the sonde:

$${v}_{i , ventilation} = \sqrt{{v}_{xi , ventilation}^{2} + {v}_{yi , ventilation}^{2} + {v}_{zi}^{2}}$$

The accuracy of the temperature measurement and humidity measurement of the sonde can be substantially improved by taking this total ventilation acting on the sensors of the sonde into account, compared to a situation, in which only the v_{zi} term of the rate of ascent is taken into account.

Some of the positioning or state of motion measurement methods (such as measurement of the state of motion of the sonde, based on the frequency shift of a radio carrier signal) provide only one of the horizontal velocity co-ordinates of the pendulum motion. The other co-ordinate should then be estimated to be the same, so that a little of the measurement accuracy of the ventilation is lost.

1. Method for correcting a radiation error in atmospheric temperature measurement, particularly when using a radiosonde (1), a rocket, or a dropsonde, in which method at least one temperature measurement sensor is used in each measuring device,
characterized in that
essentially simultaneously with the temperature measurement, the state of motion of the sonde (1) relative to the ambient air is measured by adding the squares of the rate of ascent of the sonde (1) and the components of the horizontal air current acting on the sonde (1), and using the result of the measurement for correcting the error of the temperature measurement.

2. Method according to claim 1, characterized in that the state of motion of the sonde (1) relative to the ambient air is calculated using the equation, in which
v_{zi}=(z_{zi+1}−zᵢ)/(tᵢ₊₁−tᵢ),
v_{xi,ventilation}=v_{zi}−mean value(v_{xi-n/2} . . . v_{xi+n/2})
v_{yi,ventilation}=v_{yi}−mean value(v_{yi-n/2} . . . v_{yi+n/2}).

3. Method according to claim 1, characterized in that the state of motion of the sonde (1) is measured with the aid of GPS positioning.

4. Method according to claim 1, characterized in that the state of motion of the sonde (1) is measured with the aid of radar.

5. Method according to claim 1, characterized in that the state of motion of the sonde (1) is measured with the aid of the Doppler shift of the radio transmitter of the sonde.

6. Method according to claim 1, characterized in that the state of motion of the sonde (1) is measured with the aid of radionavigation.

7. Method according to claim 1, characterized in that the state of motion of the sonde (1) is measured with the aid of radio directioning.

8. Method according to claim 1, characterized in that the state of motion of the sonde (1) is measured with the aid of inertia measurement.

9. Method according to claim 1, characterized in that the state of motion of the sonde (1) is measured with the aid of measurement of the acceleration of the radio transmitter of the sonde.

10. Method according to claim 1, characterized in that the state of motion of the sonde (1) is measured with the aid of tilt measurement.

11. Method according to claim 1, characterized in that the state of motion of the sonde (1) is measured with the aid of force measurement.

12. Method according to claim 1, characterized in that the relative state of motion of the sonde (1) is measured momentarily, or as a mean value over a longer period of time.

13. Method according to claim 1, characterized in that the measured state of motion of the sonde (1) is compared to the mean value of the state of motion of the pendular period of the sonde-balloon pendulum.

14. Method according to claim 2, characterized in that the state of motion of the sonde (1) is measured with the aid of GPS positioning.

15. Method according to claim 2, characterized in that the state of motion of the sonde (1) is measured with the aid of radar.

16. Method according to claim 2, characterized in that the state of motion of the sonde (1) is measured with the aid of the Doppler shift of the radio transmitter of the sonde.

17. Method according to claim 2, characterized in that the state of motion of the sonde (1) is measured with the aid of radionavigation.

18. Method according to claim 2, characterized in that the state of motion of the sonde (1) is measured with the aid of radio directioning.

19. Method according to claim 2, characterized in that the state of motion of the sonde (1) is measured with the aid of inertia measurement.

20. Method according to claim 2, characterized in that the state of motion of the sonde (1) is measured with the aid of measurement of the acceleration of the radio transmitter of the sonde.
